(19) United States
(12) Patent Application Publication
(10) Pub. No.: US 2017/0236161 A1
(43) Pub. Date: Aug. 17, 2017

(54) INFORMATION PROCESSOR, METHOD, AND NON-TRANSITORY COMPUTER READABLE STORAGE MEDIUM FOR PRESUMING ATTRIBUTE BASED ON FLOW OF PHYSICAL UNIT AND APPEALING

(71) Applicant: YAHOO JAPAN CORPORATION, Tokyo (JP)

(72) Inventors: Michitaka OHNO, Tokyo (JP); Takamitsu IRIYAMA, Tokyo (JP)

(73) Assignee: YAHOO JAPAN CORPORATION, Tokyo (JP)

(21) Appl. No.: 15/431,193

(22) Filed: Feb. 13, 2017

(30) Foreign Application Priority Data
Feb. 16, 2016 (JP) 2016-026538

(51) Int. Cl. G06Q 30/02

(52) U.S. Cl. CPC G06Q 30/0269

(57) ABSTRACT

An information processor includes a detecting unit (control unit), a presuming unit (control unit), and a control unit. The detecting unit detects, by detecting a transition of positional information on individual physical units by sensing with electromagnetic waves and a communication with electromagnetic waves, detects a flow of an aggregate of the physical units. The presuming unit presumes an attribute of the physical units, as an individual, part, or whole, included in the flow, based on the flow of the aggregate detected by the detecting unit. The control unit controls an output or physical action of information to or on the physical units, based on the attribute presumed by the presuming unit.

### CROSS-REFERENCE TO RELATED APPLICATION(S)

The present application claims priority to and incorporates by reference the entire contents of Japanese Patent Application No. 2016-026538 filed in Japan on Feb. 16, 2016.

### BACKGROUND OF THE INVENTION

1. Field of the Invention

The present invention relates to an information processor, a method, and a non-transitory computer readable storage medium for presuming an attribute based on a flow of a physical unit and appealing.

2. Description of the Related Art

Conventionally, widely known are systems called digital signage that use a display placed in stores, facilities, streets, and other places to distribute content, such as advertisements. There have been developed, for example, techniques for displaying serial advertisements on a plurality of displays arranged at a road while staggering the display time in order of the regular route of the road based on a flow of people (hereinafter, referred to as a people flow) detected by a camera or the like.

The technique described in Japanese Patent No. 4464054, however, displays the advertisements independently of the attributes of a group (mass) of people to be provided with the advertisements. As a result, the technique cannot effectively provide the advertisements, thereby failing to increase the effects of the advertisements.

### SUMMARY OF THE INVENTION

It is an object of the present invention to at least partially solve the problems in the conventional technology.

According to one aspect of an embodiment, an information processor includes a detecting unit that, by detecting a transition of positional information on individual physical units by sensing with electromagnetic waves and a communication with electromagnetic waves, detects a flow of an aggregate of the physical units, a presuming unit that presumes an attribute of the physical units, as an individual, part, or whole, included in the flow, based on the flow of the aggregate detected by the detecting unit, and a control unit that controls an output or physical action of information to or on the physical units, based on the attribute presumed by the presuming unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a main control configuration of devices constituting an information processing system according to an embodiment;

FIG. 2 is a flowchart of an example of operations performed by the information processing system according to the present embodiment;

FIG. 3 is a diagram of an example of a table used to manage event information;

FIG. 4 is a flowchart of an example of attribute presumption processing performed by the image processing system according to the present embodiment; and

FIG. 5 is a conceptual diagram of processing for presuming attributes of persons constituting detected people flows and providing information based on the presumed attributes.

### DETAILED DESCRIPTION OF THE PREFERRED EMBODIMENTS

Exemplary embodiments are described below in greater detail with reference to the accompanying drawings.

1. Explanation of the Configuration

An embodiment according is described below in greater detail with reference to the accompanying drawings.

1-1. Explanation of the System Configuration

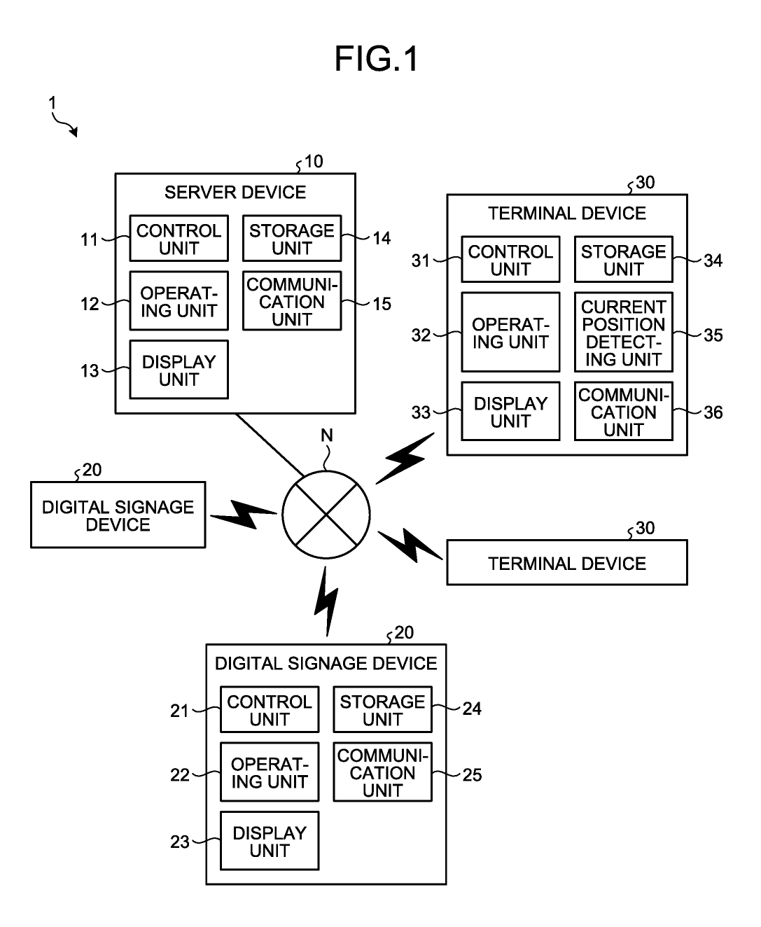

A configuration of an information processing system 1 according to the present embodiment is described first. As illustrated in FIG. 1, the information processing system 1 includes a server device 10, digital signage devices 20, and terminal devices 30. The server device 10 serves as an information processor, and the terminal devices 30 serve as information terminals. The devices constituting the information processing system 1 are connected to a communication network N. Specifically, the communication network N is the Internet, or a telephone network or a mobile phone communication network of a telecommunications carrier, for example.

The server device 10 is an information device, such as a personal computer (PC) and a work station (WS). The server device 10 accumulates positional information transmitted from the terminal devices 30 through the communication network N. While the server device 10 is one device, the present embodiment is not limited thereto. The server device 10 may be a plurality of devices.

The digital signage devices 20 are terminal devices placed at a road for people, for example, to display video and information using digital technologies in display and communications. The digital signage devices 20 use the communication network N (specifically, communication lines of the digital signage devices 20 and a wireless local area network (LAN), for example) to perform communications with the server device 10.

The terminal devices 30 are mobile terminal devices, such as mobile phones and smart devices including smartphones and tablets, belonging to and used by users. The terminal devices 30 each have an installed application (hereinafter, referred to as a map application) that performs processing of displaying a map of an area around the user's current location and processing of searching for a route to a destination and exhibiting a guide route based on the search result, for example. The terminal devices 30 use the communication network N (specifically, communication lines of the terminal devices 30 and a wireless LAN, for example) to perform communications with the server device 10.

1-2. Explanation of the Configuration of the Server Device

The following describes a configuration of the server device 10. The server device 10 includes a control unit 11, an operating unit 12, a display unit 13, a storage unit 14, and a communication unit 15.

The control unit 11 centrally controls the operations of the server device 10. Specifically, the control unit 11 includes a central processing unit (CPU), a read only memory (ROM), and a random access memory (RAM), for example. The control unit 11 collectively controls the units of the server device 10 by the CPU cooperating with program data stored in the ROM or the storage unit 14 and loaded to the work area of the RAM.

The operating unit 12, for example, includes a keyboard having character input keys, numeral input keys, and keys corresponding to other various functions, and a pointing device, such as a mouse. The operating unit 12 receives operating input from a user and outputs operating signals based on the operating input to the control unit 11. The display unit 13 includes a display, such as a liquid crystal display (LCD), and displays an image based on display control signals output from the control unit 11 on a display screen.

The storage unit 14 is a hard disk drive (HDD) or a semiconductor memory, for example. The storage unit 14 stores therein data, such as program data and various types of setting data, in a manner readable and writable by the control unit 11. The storage unit 14 also stores therein map data, for example. The map data includes map information (on a plurality of scales) covering a large area, road information, and various types of symbol information on facilities, seas, and rivers, for example.

The communication unit 15 is a communication interface including a communication integrated circuit (IC) and a communication connector, for example. The communication unit 15 performs data communications through the communication network N using a predetermined communication protocol under the control of the control unit 11.

1-3. Explanation of the Configuration of the Digital Signage Device

The following describes a configuration of the digital signage device 20. The digital signage device 20 includes a control unit 21, an operating unit 22, a display unit 23, a storage unit 24, and a communication unit 25.

The control unit 21 centrally controls the operations of the digital signage device 20. Specifically, the control unit 21 includes a CPU, a ROM, and a RAM, for example. The control unit 21 collectively controls the units of the digital signage device 20 by the CPU cooperating with program data stored in the ROM or the storage unit 24 and loaded to the work area of the RAM.

The operating unit 22, for example, includes a keyboard having character input keys, numeral input keys, and keys corresponding to other various functions, and a pointing device, such as a mouse. The operating unit 22 receives operating input from a user and outputs operating signals based on the operating input to the control unit 21. The display unit 23 includes a display, such as an LCD and a flat panel display (FPD) having organic electro-luminescence (EL) elements. The display unit 23 displays an image based on display control signals output from the control unit 21 on a display screen. The display unit 23, for example, displays an advertisement based on advertising information transmitted from the server device 10. The display unit 23 serves as a display unit according to the present embodiment.

The storage unit 24 is an HDD or a semiconductor memory, for example. The storage unit 24 stores therein data, such as program data and various types of setting data, in a manner readable and writable by the control unit 21.

The communication unit 25 is a communication interface including a communication IC and a communication connector, for example. The communication unit 25 performs data communications through the communication network N using a predetermined communication protocol under the control of the control unit 21.

1-4. Explanation of the Configuration of the Terminal Device

The following describes a configuration of the terminal device 30. The terminal device 30 includes a control unit 31, an operating unit 32, a display unit 33, a storage unit 34, a current position detecting unit 35, and a communication unit 36.

The control unit 31 centrally controls the operations of the terminal device 30. Specifically, the control unit 31 includes a CPU, a ROM, and a RAM, for example. The control unit 31 collectively controls the units of the terminal device 30 by the CPU cooperating with program data stored in the ROM or the storage unit 34 and loaded to the work area of the RAM.

The operating unit 32 includes a key input unit having a home button, for example, and a touch panel integrated with the display unit 33. The operating unit 32 receives operating input from a user and outputs operating signals based on the operating input to the control unit 31. The display unit 33 includes a display, such as an LCD and an FPD having organic EL elements. The display unit 33 displays an image based on display control signals output from the control unit 31 on a display screen.

The storage unit 34 is an HDD or a semiconductor memory, for example. The storage unit 34 stores therein data, such as program data and various types of setting data, in a manner readable and writable by the control unit 31.

The current position detecting unit 35 includes a global positioning system (GPS) module, for example. The GPS module includes a GPS antenna, for example. The GPS antenna receives GPS signals transmitted from a plurality of GPS satellites launched into low Earth orbit. The GPS antenna receives GPS signals transmitted from at least three GPS satellites. The GPS antenna detects an absolute current position (latitude and longitude) of the terminal device 30 based on the received GPS signals and outputs the current position to the control unit 31.

The communication unit 36 includes an antenna and a communication circuit and performs wireless communications with external devices under the control of the control unit 31. Specifically, the communication unit 36 performs data communications through the communication network N via a base station.

2. Explanation of Operations

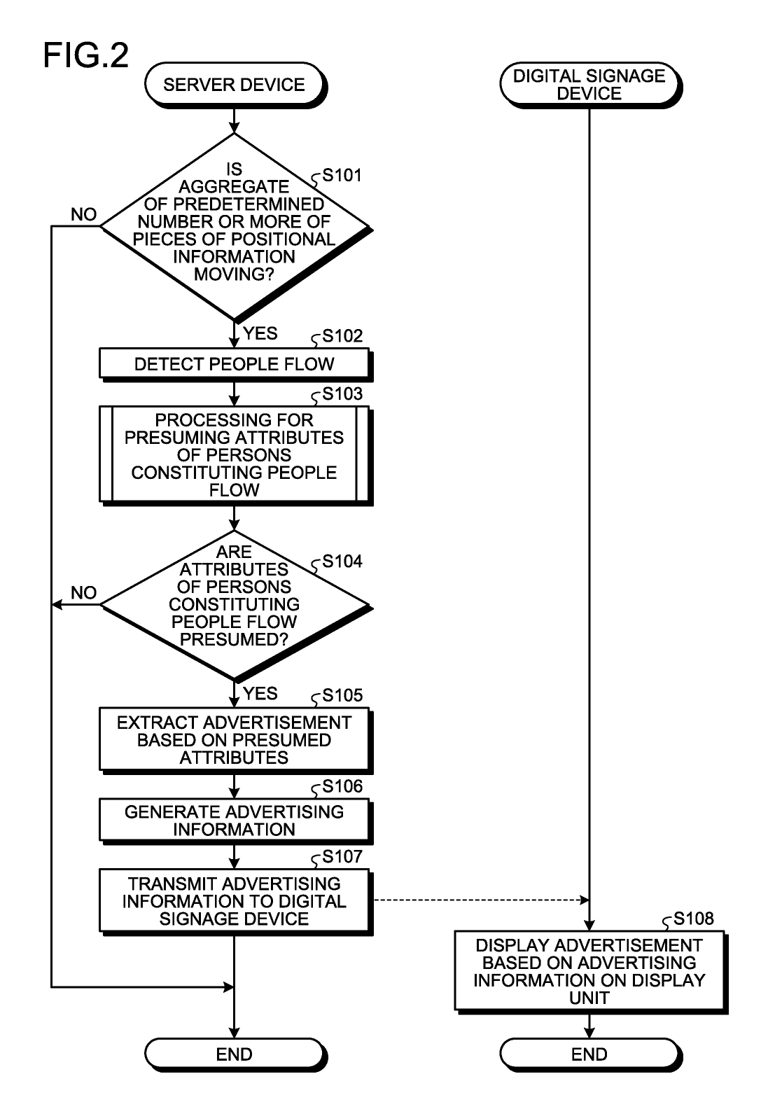

The following describes specific operations performed by the information processing system 1 according to the present embodiment with reference to the flowchart illustrated in FIG. 2. Specifically, the following describes processing performed by the server device 10 to detect a people flow based on positional information transmitted from the terminal devices 30, presume attributes of persons constituting the detected people flow, and provide information based on the presumed attributes. While the processing is periodically performed at predetermined intervals (e.g., at intervals of five minutes), the present embodiment is not limited thereto. The processing may be performed at desired intervals depending on the conditions.

The following describes processing performed until when the control unit 11 of the server device 10 acquires positional information transmitted from the terminal devices 30 as preprocessing. The control unit 31 of the terminal device 30 acquires positional information on the terminal device 30. The positional information includes at least information on the current position (latitude and longitude) detected by the current position detecting unit 35. Subsequently, the control unit 31 transmits the acquired positional information to the server device 10 via the communication unit 36. The processing described above performed by the control unit 31 of the terminal device 30 is carried out as a function of the map application regardless of whether the map application installed in the terminal device 30 is started. While the processing is periodically performed at predetermined intervals (e.g., at intervals of five seconds), the present embodiment is not limited thereto. The processing may be performed at desired intervals depending on the conditions.

By performing the processing described above, the control unit 11 of the server device 10 acquires the positional information transmitted from the terminal devices 30. In other words, the control unit 11 serves as a positional information acquiring unit according to the present embodiment. The following describes the processing performed by the server device 10, that is, the processing of detecting a people flow, presuming attributes of persons constituting the detected people flow, and providing information based on the presumed attributes.

As illustrated in FIG. 2, the control unit 11 of the server device 10 aggregates the positional information transmitted from the terminal devices 30 and determines whether an aggregate of a predetermined number or more of pieces of positional information is moving (Step S101). The aggregate of pieces of positional information is a group of pieces of positional information that can be considered to be moving substantially together in the same direction within a predetermined range even if they vary in the moving speed and the moving position to some extent. If the control unit 11 determines that an aggregate of a predetermined number or more of pieces of positional information is moving (Yes at Step S101), the control unit 11 detects the flow of the aggregate of the predetermined number or more of pieces of positional information as a people flow (Step S102). In other words, the control unit 11 serves as a detecting unit according to the present embodiment that detects a people flow based on positional information transmitted from the terminal devices 30. The people flow according to the present embodiment is a flow of a group of a predetermined number or more of persons that can be considered to be moving substantially together in the same direction. By contrast, if the control unit 11 determines that no aggregate of a predetermined number or more of pieces of positional information is moving (No at Step S101), the control unit 11 determines that no people flow is present and ends the processing.

While the control unit 11 detects a people flow based on the positional information at Steps S101 and S102, the present embodiment is not limited thereto. Instead of or in addition to the positional information, the control unit 11 may detect a people flow based on a deviation from normal traffic, for example. The traffic is an amount of persons passing through a certain position per unit time. The traffic according to the present embodiment is measured in each moving direction. The control unit 11, for example, calculates a deviation value in each moving direction at positions on the assumption that the normal traffic is 50, which is the average. The control unit 11 detects a group of persons moving in a moving direction having a deviation value separated above by 1σ or larger from the normal traffic (average 50) as a people flow. The example described above is given by way of example only, and the calculated deviation value simply needs to be separated above from the normal traffic. The control unit 11, for example, may detect a group of persons moving in a moving direction having a deviation value separated above by 2σ or larger from the normal traffic as a people flow.

The normal traffic is calculated based on statistical information obtained under the same conditions, for example. Specifically, the normal traffic is calculated by a predetermined calculation method based on statistical information obtained under the same conditions in the date and time, the day of the week, the period of time, and the weather, for example. The predetermined calculation method may appropriately use a conventional statistical technique. The predetermined calculation method may be a method of calculating the average or a method of calculating the median, for example.

Subsequently, the control unit 11 performs processing for presuming attributes of persons constituting a people flow based on the people flow detected at Step S102 (Step S103). In other words, the control unit 11 serves as a presuming unit according to the present embodiment. The attributes of persons are properties and characteristics common to the persons. Examples of the attributes of persons include, but are not limited to, behavior histories, demographics, interests and concerns, etc.

An example of the processing for presuming attributes of persons constituting a people flow is processing for presuming attributes based on an occasion around the people flow detected at Step S102. The occasion is a factor that affects movement of persons in a specific direction. Examples of the occasion include, but are not limited to, events such as fireworks displays and concerts, weather conditions, disasters such as torrential rain, earthquakes, and fires, cases, accidents, etc. If a people flow is generated nearby by torrential rain, for example, the control unit 11 can presume attributes of being interested in rain gears, such as umbrellas. If a fire occurs, and a people flow is generated by curious onlookers heading for the scene of the fire, for example, the control unit 11 can presume attributes of being interested in fire insurance.

Another example of the processing for presuming attributes of persons constituting a people flow is processing for presuming attributes based on a start and end point of the people flow detected at Step S102. The start and end point according to the present embodiment is not limited to the start point and the end point and may be the start point alone or the end point alone. In other words, the control unit 11 may presume the attributes based on the start point and the end point or on the start point or the end point. If the start point or the end point of a people flow is the sea, for example, the control unit 11 can presume attributes of being interested in sea bathing, surfing, sunburning, and the like. If the start point or the end point of a people flow is Ginza, for example, the control unit 11 can presume attributes of being interested in shopping, brands, fashions, and the like.

The control unit 11 may presume the attributes especially based on a facility at the start and end point. If the start point or the end point of a people flow is Tokyo Dome, for example, the control unit 11 can presume attributes of being interested in baseball, music, Yomiuri Giants, and the like. If the start point or the end point of a people flow is Yoyogi Park, for example, the control unit 11 can presume attributes of being interested in walking, cycling, basketball, and the like. The control unit 11 may presume the attributes especially based on the category of the facility at the start and end point. If the start point or the end point of a people flow is a baseball park, for example, the control unit 11 can presume attributes of being interested in baseball and the like. If the start point or the end point of a people flow is a park, for example, the control unit 11 can presume attributes of being interested in walking, cycling, jogging, and the like.

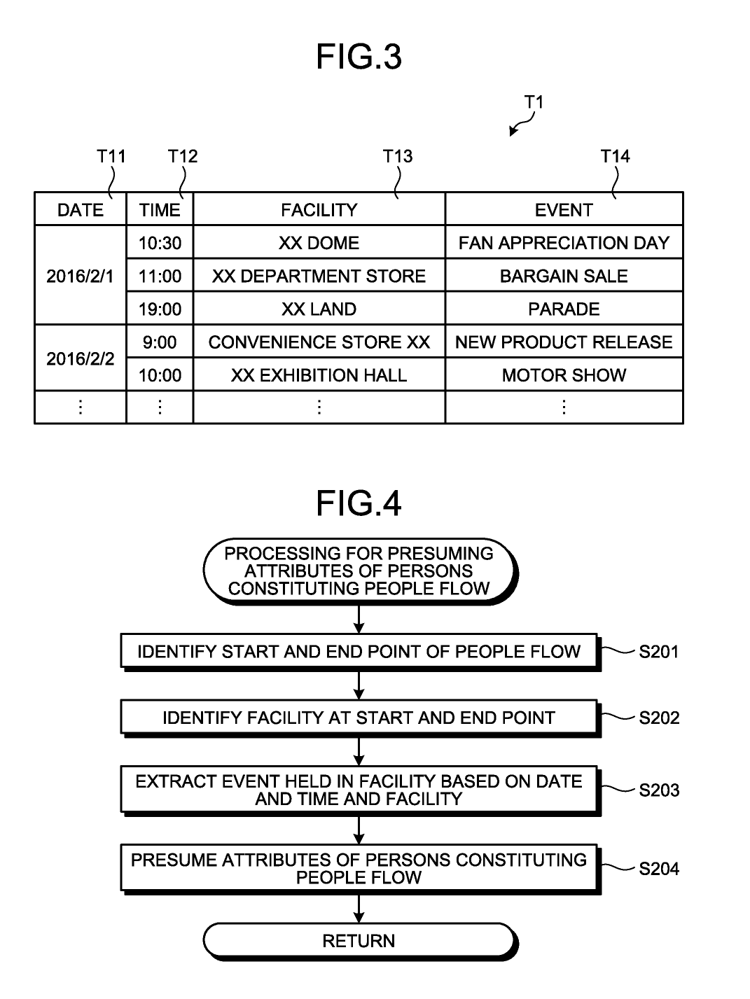

The control unit 11 may presume the attributes especially based on a date and time and an event held in the facility at the start and end point. FIG. 3 illustrates an example of a table T1 used to manage event information. The table T1 is created based on event information acquired in advance and stored in the storage unit 14, for example. The table T1 has fields of date T11, time T12, facility T13, and event T14. Date T11 indicates a day when an event is held. Time T12 indicates time when an event is held. Facility T13 indicates a facility where an event is held. Event T14 indicates an event to be held. FIG. 3 illustrates an example of the table T1 including a record in which date T11 “2016/2/1”, time T12 “10:30”, and facility T13 “XX dome” are associated with event T14 “fan appreciation day”, for example. The first record in the table T1 indicates that the “fan appreciation day (event T14)” is held in the “XX dome (facility T13)” at “10:30 (time T12)” on “2016/2/1 (date T11)”.

The following describes processing for presuming attributes based on a date and time and an event held in the facility at the start and end point with reference to the flowchart illustrated in FIG. 4. The processing is started when a people flow is detected at Step S102.

As illustrated in FIG. 4, the control unit 11 of the server device 10 identifies the start and end point of the people flow detected at Step S102 (Step S201). The control unit 11, for example, identifies the position of positional information positioned on the uppermost stream of the people flow detected at Step S102 as the start point. Furthermore, the control unit 11, for example, identifies the position of positional information positioned on the lowermost stream when the people flow detected at Step S102 stops as the end point. The method for identifying the start and end point is not limited to the example described above, and the present embodiment may appropriately use a desired method.

Subsequently, the control unit 11 identifies a facility at the start and end point identified at Step S201 (Step S202). The control unit 11, for example, identifies a famous facility positioned near the start and end point identified at Step S201 as the facility at the start and end point. The method for identifying the facility at the start and end point is not limited to the example described above, and the present embodiment may appropriately use a desired method.

Subsequently, based on a date and time and the facility at the start and end point identified at Step S202, the control unit 11 extracts an event held in the facility (Step S203). Specifically, the control unit 11 refers to the table T1 (refer to FIG. 4) used to manage the event information stored in the storage unit 14. The control unit 11 uses the date and time and the facility at the start and end point as a search key to extract an event held in the facility. While the date and time is set to the current time, the time to be a search target includes time from the current time to the time after a predetermined period of time (e.g., two hours). This is because participants of an event usually start to arrive at a facility where the event is held the predetermined period of time earlier than the start time of the event. Let us assume a case where the date and time is “10:00” on “2016/2/1”, and the facility at the end point is the “XX dome”, for example. In the example illustrated in FIG. 4, the control unit 11 searches for an event held in the “XX dome (facility T13)” at “10:00 to 12:00 (time T12)” on “2016/2/1 (date T11)”. As a result, the control unit 11 extracts the “fan appreciation day (event T14)” as the event held in the facility. If the control unit 11 does not find any corresponding event in the processing at Step S203, the control unit 11 may perform the processing at Step S202 again to identify another facility.

Subsequently, the control unit 11 presumes attributes of persons constituting the people flow based on the event extracted at Step S203 (Step S204). If the extracted event is a bargain sale, for example, the control unit 11 can presume attributes of being interested in bargain sales, shopping, and the like. If the extracted event is a motor show, for example, the control unit 11 can presume attributes of being interested in cars and the like. By performing the processing described above, the server device 10 can presume the attributes of the persons constituting the people flow based on the date and time and the event held in the facility at the start and end point of the people flow.

Still another example of the processing for presuming attributes of persons constituting a people flow is processing for presuming attributes based on online behaviors of persons constituting the people flow detected at Step S102. Specifically, based on the positional information in the people flow detected at Step S102, the control unit 11 of the server device 10 identifies persons constituting the people flow. The control unit 11 presumes attributes based on online behaviors of the persons constituting the people flow.

The control unit 11 according to the present embodiment acquires the positional information using the functions of the map application installed in the terminal devices 30. The control unit 11 stores, in the storage unit 14 or the like, information on attributes of users in a manner associated with identification information (e.g., terminal IDs) of the terminal devices 30 belonging to the respective users acquired by their subscription to the map application, for example. To use the map application, a user usually needs to log in. As a result, the transmitted positional information includes the identification information on the terminal device 30. Based on the acquired positional information, the control unit 11 can identify the user. The control unit 11 analyzes registration information, behaviors, and other data on the identified user, thereby extracting the attributes of the user. The control unit 11 especially analyzes online behaviors of the identified user, thereby extracting the attributes of the user. By performing the processing described above on each piece of the positional information in an area, the control unit 11 can extracts the attributes of the persons in the area. If part of the identified users bought an electronic ticket of the most recent event online, for example, they can be presumed to be participants of the event. Consequently, the control unit 11 can extract the attributes based on the event.

The control unit 11 determines whether it can presume the attributes of the persons constituting the people flow as a result of the processing for presuming the attributes of the persons constituting the people flow at Step S103 (Step S104). If the control unit 11 determines that it can presume the attributes of the persons constituting the people flow (Yes at Step S104), the control unit 11 performs the processing at Step S105. By contrast, if the control unit 11 determines that it fails to presume the attributes of the persons constituting the people flow (No at Step S104), the control unit 11 ends the processing.

Subsequently, the control unit 11 extracts an advertisement based on the attributes presumed at Step S103 (Step S105). If the attributes presumed at Step S103 are being interested in baseball, the control unit 11 extracts an advertisement for baseball goods, for example. If the presumed attributes are young women, the control unit 11 extracts an advertisement for cosmetics for young women, for example.

Subsequently, the control unit 11 generates advertising information for causing the display unit 23 of the digital signage device 20 to display the advertisement extracted at Step S105 (Step S106). Subsequently, the control unit 11 transmits the advertising information generated at Step S106 to the digital signage device 20 via the communication unit 15 (Step S107). By performing the processing described above, the control unit 11 serves as a providing unit according to the present embodiment.

The control unit 21 of the digital signage device 20 displays, on the display unit 23, the advertisement based on the advertising information transmitted from the server device 10 at Step S107 (Step S108). By performing the processing described above, the present embodiment can cause the display unit 23 to display the advertisement based on the attributes of the persons constituting the people flow detected at Step S102.

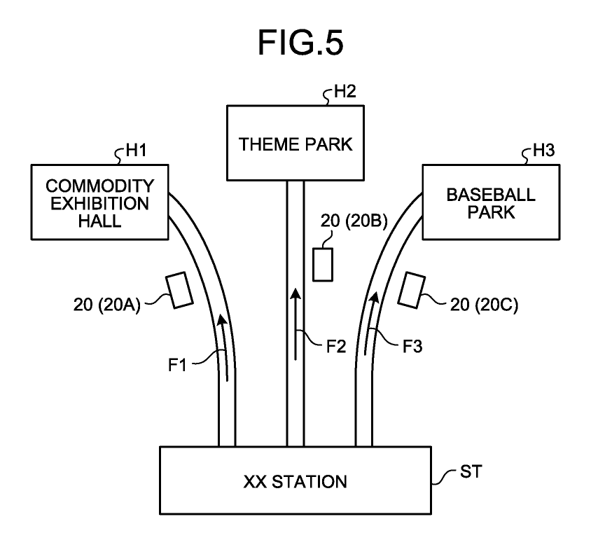

FIG. 5 is a conceptual diagram of processing for presuming attributes of persons constituting detected people flows and providing information based on the presumed attributes. FIG. 5 especially illustrates an example of processing for providing information based on the attributes presumed based on the facilities at the start and end points of the detected people flows. FIG. 5 illustrates a state around an XX station ST, for example. There are facilities of a commodity exhibition hall H1, a theme park H2, and a baseball park H3 around the XX station ST. The digital signage devices 20 (20A, 20B, and 20C) are placed on the routes leading to the respective facilities. In the example illustrated in FIG. 5, the control unit 11 performs the processing at Steps S101 and S102, thereby detecting a people flow F1 heading for the commodity exhibition hall H1, a people flow F2 heading for the theme park H2, and a people flow F3 heading for the baseball park H3.

The control unit 11 presumes attributes of the persons constituting the people flows based on the facilities at the start and end points of the respective detected people flows. Specifically, the control unit 11 presumes the attributes to be “being interested in the economy”, for example, based on the commodity exhibition hall H1 serving as the facility at the end point (famous facility positioned near the end point) of the detected people flow F1. The control unit 11 presumes the attributes to be “being interested in theme parks”, for example, based on the theme park H2 serving as the facility at the end point of the detected people flow F2. The control unit 11 presumes the attributes to be “being interested in baseball”, for example, based on the baseball park H3 serving as the facility at the end point of the detected people flow F3. Subsequently, the control unit 11 extracts advertisements based on the presumed attributes. The control unit 11 generates pieces of advertising information for causing the display units 23 of the respective digital signage devices 20 to display the advertisements and transmits them to the respective digital signage devices 20. The control unit 11, for example, transmits advertising information for displaying an advertisement relating to the economy to the digital signage device 20A. The control unit 11 transmits advertising information for displaying an advertisement relating to theme parks to the digital signage device 20B. The control unit 11 transmits advertising information for displaying an advertisement relating to baseball to the digital signage device 20C.

The control units 21 of the digital signage devices 20 display, on the respective display units 23, the advertisements based on the pieces of advertising information transmitted from the server device 10. The display unit 23 of the digital signage device 20A, for example, displays the advertisement relating to the economy. The display unit 23 of the digital signage device 20B displays the advertisement relating to theme park. The display unit 23 of the digital signage device 20C displays the advertisement relating to baseball. By performing the processing described above, the present embodiment can presume the attributes of the persons constituting the detected people flow and provide information based on the presumed attributes.

3. Advantageous Effects

As described above, the information processor (server device 10) according to the present embodiment includes the detecting unit (control unit 11), the presuming unit (control unit 11), and the providing unit (control unit 11). The detecting unit detects a people flow. The presuming unit presumes attributes of persons constituting a people flow based on the people flow detected by the detecting unit. The providing unit provides information based on the attributes presumed by the presuming unit. Consequently, the information processor according to the present embodiment can provide information based on the attributes of a group (mass) of people to be provided with the information, thereby increasing the effects in providing the information.

The detecting unit of the information processor according to the present embodiment detects the people flow based on a deviation from normal traffic. Consequently, the information processor according to the present embodiment can extract a people flow generated by special circumstances, such as an event, thereby securing more opportunities to provide information.

The presuming unit of the information processor according to the present embodiment presumes the attributes based on an occasion around the people flow detected by the detecting unit. Even if a people flow is generated by an unexpected occasion hard to predict from facilities, environments, and other factors around the detected people flow, the information processor according to the present embodiment can provide information based on the attributes. Consequently, the information processor according to the present embodiment can provide information depending on the circumstances.

The presuming unit of the information processor according to the present embodiment presumes the attributes based on the start and end point of the people flow detected by the detecting unit. Consequently, the information processor according to the present embodiment can readily identify generation factors of the people flow, thereby readily presuming the attributes of the persons constituting the people flow.

The presuming unit of the information processor according to the present embodiment presumes the attributes based on a facility at the start and end point. Consequently, the information processor according to the present embodiment can readily identify generation factors of the people flow, thereby readily presuming the attributes of the persons constituting the people flow.

The presuming unit of the information processor according to the present embodiment presumes the attributes based on a date and time and an event held in a facility at the start and end point. Consequently, the information processor according to the present embodiment can accurately identify generation factors of the people flow, thereby accurately presuming the attributes of the persons constituting the people flow.

The information processor according to the present embodiment includes the positional information acquiring unit (control unit 11) that acquires positional information on the information terminal (terminal device 30). The detecting unit detects the people flow based on the positional information acquired by the positional information acquiring unit. Consequently, the information processor according to the present embodiment can readily detect the people flow, thereby reducing costs and processing time.

The presuming unit of the information processor according to the present embodiment identifies the persons constituting the people flow based on the positional information in the people flow detected by the detecting unit. The presuming unit presumes the attributes based on online behaviors of the persons constituting the people flow. Consequently, the information processor according to the present embodiment can presume the attributes based on actual behaviors of the persons constituting the people flow, thereby increasing the accuracy in presumption of the attributes.

The providing unit of the information processor according to the present embodiment causes the display unit (display unit 23) arranged at a road for the people flow detected by the detecting unit to display information. Consequently, the information processor according to the present embodiment can cause the persons to view the information based on the attributes of the persons constituting the people flow, thereby increasing the effects in providing the information.

While the embodiment has been specifically described, the embodiment above is not intended to limit the embodiment. Various changes and modifications may be made without departing from the spirit of the embodiment.

4. Modifications

While the embodiment above extracts, at Step S105, an advertisement based on the attributes presumed at Step S103, for example, the present embodiment is not limited thereto. Specifically, the object extracted in the processing at Step S105 may be any information as long as it is based on the attributes presumed at Step S103. Instead of the advertisement, the embodiment may extract news or other content, for example.

While the digital signage device 20 according to the embodiment above displays information (e.g., advertisements, news, and other content) transmitted from the server device 10 on the display unit 23, the present embodiment is not limited thereto. The digital signage device 20, for example, may include an audio output unit (audio output unit), such as a speaker, instead of the display unit 23. In this case, the digital signage device 20 may output audio information (e.g., audio advertisements, audio news, and other audio content) as audio. Needless to say, the digital signage device 20 may include both the display unit 23 and the audio output unit. As described above, the control unit 11 of the server device 10 causes the audio output unit arranged at a road for the people flow detected by the detecting unit to output the information as audio. Consequently, the server device 10 can cause the persons to listen to the information based on the attributes of the persons constituting the people flow, thereby increasing the effects in providing the information.

Instead of causing the display unit 23 of the digital signage device 20 to display the information, the embodiment may cause output units (the display units 33 and audio output units (not illustrated)) of the terminal devices 30 belonging to the respective persons constituting the people flow detected at Step S102 to output (display and output as audio) the information. The embodiment may appropriately combine the configuration that causes the display unit 23 of the digital signage device 20 to display the information transmitted from the server device 10, the configuration that causes the audio output unit of the digital signage device 20 to output the information as audio, and the configuration that causes the output units of the terminal devices 30 to output the information. As described above, the control unit 11 of the server device 10 causes the output units of the information terminals (terminal devices 30) belonging to the respective persons constituting the people flow detected by the detecting unit to output the information. Consequently, the server device 10 can cause the persons to recognize the information based on the attributes of the persons constituting the people flow, thereby increasing the effects in providing the information.

While the embodiment above detects the people flow based on the positional information, the present embodiment is not limited thereto. In other words, any technique may be used as long as it can detect a people flow. Instead of acquiring the positional information, the embodiment may analyze an image taken by a camera to detect a people flow, for example. In this case, the embodiment may detect a people flow based on the number of people or a deviation from normal traffic.

While the embodiment above acquires the positional information on the terminal devices 30 using the functions of the map application installed in the terminal devices 30, the present embodiment is not limited thereto. In other words, any application may be used as long as it has a function to continuously acquire the positional information. The embodiment, for example, may use a transfer guide application that provides a route search function in public transportation, such as trains. The transfer guide application acquires positional information to provide a service of preferentially displaying the nearest station, for example. Alternatively, the embodiment may use a disaster prevention application that provides a function to distribute evacuation information, earthquake early warning, disaster information on a tsunami, torrential rain, and other disasters, and forecasts and predictions. The disaster prevention application acquires positional information especially to provide a service of notifying users of approach of disasters that may possibly endanger the users, such as a tsunami and torrential rain, for example.

While the control unit 11 of the server device 10 according to the embodiment above performs the processing relating to advertisement distribution (e.g., processing of extracting an advertisement and processing of generating advertising information and transmitting it to the digital signage device 20), the present embodiment is not limited thereto. The information processing system 1 may include an advertisement distribution server that performs the processing relating to advertisement distribution separately from the server device 10, for example. While the embodiment above describes the server device 10 as the information processor according to the present embodiment, the embodiment is not limited thereto. The detecting unit, the presuming unit, the providing unit, and other functions (e.g., the positional information acquiring unit) according to the present embodiment may be included in the digital signage device 20, for example. With this configuration, the digital signage device 20 may serve as the information processor according to the present embodiment.

The aspects disclosed in the present application may be provided as a method and a computer program, for example. In the categories of the method and the computer program, “units” described in the category of the device are appropriately changed into “processes” or “steps”, for example. The order of the processing and the steps is not limited to the one directly described in the present application. The order may be changed, and part of the processing may be collectively performed, or each part of the processing may be performed as needed.

The specific configurations and the specific operations of the server device, the digital signage device, and the terminal device may be appropriately changed without departing from the spirit of the present embodiment.

The embodiment above can be applied not only to an information processor, an information processing method, and a non-transitory computer readable storage medium but also to an information processor for presuming an attribute based on a flow of a physical unit and appealing. This information processor includes a detecting unit (corresponding to control unit 11) that, by detecting a transition of positional information on individual physical units by sensing with electromagnetic waves and a communication with electromagnetic waves, detects a flow of an aggregate of the physical units, a presuming unit (corresponding to control unit 11) that presumes an attribute of the physical units, as an individual, part, or whole, included in the flow, based on the flow of the aggregate detected by the detecting unit, and a control unit (corresponding to control unit 11) that controls an output or physical action of information to or on the physical units, based on the attribute presumed by the presuming unit.

The information processor for presuming an attribute based on a flow of a physical unit and appealing can be applied not only to the field of providing information but also to other fields such as an organism management and prevention of an excessive approach of aircraft and spacecraft. “an information processor comprising: a detecting unit that detects a people flow; a presuming unit that presumes an attribute of persons constituting the people flow based on the people flow detected by the detecting unit; and a providing unit that provides information based on the attribute presumed by the presuming unit” can be performed alone without requiring a configuration “an information processor comprising: a detecting unit that, by detecting a transition of positional information on individual physical units by sensing with electromagnetic waves and a communication with electromagnetic waves, detects a flow of an aggregate of the physical units; a presuming unit that presumes an attribute of the physical units, as an individual, part, or whole, included in the flow, based on the flow of the aggregate detected by the detecting unit; and a control unit that controls an output or physical action of information to or on the physical units, based on the attribute presumed by the presuming unit”.

The present embodiment can increase the effects in providing information.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processor comprising:
a detecting unit that, by detecting a transition of positional information on individual physical units by sensing with electromagnetic waves and a communication with electromagnetic waves, detects a flow of an aggregate of the physical units;
a presuming unit that presumes an attribute of the physical units, as an individual, part, or whole, included in the flow, based on the flow of the aggregate detected by the detecting unit; and
a control unit that controls an output or physical action of information to or on the physical units, based on the attribute presumed by the presuming unit.

2. The information processor according to claim 1, wherein
the detecting unit detects a people flow;
the presuming unit presumes an attribute of persons constituting the people flow based on the people flow detected by the detecting unit; and
the control unit is provided with a providing unit that provides information based on the attribute presumed by the presuming unit.

3. The information processor according to claim 2, wherein the detecting unit detects the people flow based on a deviation from normal traffic.

4. The information processor according to claim 2, wherein the presuming unit presumes the attribute based on an occasion around the people flow detected by the detecting unit.

5. The information processor according to claim 2, wherein the presuming unit presumes the attribute based on a start and end point of the people flow detected by the detecting unit.

6. The information processor according to claim 5, wherein the presuming unit presumes the attribute based on a facility at the start and end point.

7. The information processor according to claim 6, wherein the presuming unit presumes the attribute based on a date and time and an event held in the facility at the start and end point.

8. The information processor according to claim 2, further comprising:
a positional information acquiring unit that acquires positional information on an information terminal, wherein
the detecting unit detects the people flow based on the positional information acquired by the positional information acquiring unit.

9. The information processor according to claim 8, wherein the presuming unit identifies the persons constituting the people flow based on the positional information in the people flow detected by the detecting unit and presumes the attribute based on an online behavior of the persons constituting the people flow.

10. The information processor according to claim 2, wherein the providing unit causes a display unit arranged at a road for the people flow detected by the detecting unit to display the information.

11. The information processor according to claim 2, wherein the providing unit causes an audio output unit arranged at the road for the people flow detected by the detecting unit to output the information as audio.

12. The information processor according to claim 2, wherein the providing unit causes an output unit of an information terminal belonging to the persons constituting the people flow detected by the detecting unit to output the information.

13. An information processing method performed by an information processor, the method comprising:
detecting a people flow;
presuming an attribute of persons constituting the people flow based on the detected people flow; and
providing information based on the presumed attribute.

14. A non-transitory computer-readable storage medium having stored therein a computer program causing a computer to execute a process comprising:
detecting a people flow;
presuming an attribute of persons constituting the people flow based on the detected people flow; and
providing information based on the presumed attribute.
